(19) United States
(12) Patent Application Publication
(10) Pub. No.: US 2011/0023271 A1
(43) Pub. Date: Feb. 3, 2011

(54) HINGE

(75) Inventor: WEN-BIN SHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/554,970

(22) Filed: Sep. 7, 2009

(30) Foreign Application Priority Data
Aug. 3, 2009 (CN) 200920307280.5

(51) Int. Cl. E05D 11/10

(52) U.S. Cl. 16/334; 16/319

(57) ABSTRACT

A hinge includes a first connecting member, a shaft fixed to the first connecting member, a second connecting member rotatably mounted to the shaft, a first interfering member fixed to the second connecting member, a first stopping member having a resisting surface, a second interfering member having a stop surface, and a fastener fixed to the shaft. A resisting block extends from the second connecting member. A first depressed portion and a second depressed portion are defined in the first interfering member, and a withstanding protrusion protrudes from the first interfering member. A first protrusion and a second protrusion extend from the second interfering member, capable of engaging in the first and second depressed portions. When the second connecting member is rotated relative to the first connecting member to a predetermined degree, the resisting block and the withstanding protrusion resist against the resisting surface and the stopping surface, respectively.

### BACKGROUND

1. Technical Field

The disclosure relates to a hinge.

2. Description of Related Art

A collapsible device, such as a notebook computer, or a clamshell mobile phone, generally including a main body and a cover often uses a hinge to interconnect the main body and the cover. The hinge allows the cover to be rotatable with respect to the main body, and to be folded with the main body for saving space.

A hinge normally includes a first element and a second element fixed to the main body and the cover of the collapsible device, respectively. The first and second elements are rotatable relative to and in friction engagement with each other for maintaining the cover at any angle with respect to the main body. During rotation, the cover can maintain at any angle with respect to the main body by friction between the first and second elements. However, the first and second elements are not durable after frequent usage and due to wear and tear, resulting in preventing the cover from being able to stay at certain desirable positions. When one of the first and second elements is worn out, the cover cannot maintain stability at certain desirable positions with respect to the main body, which creates quite a inconvenience for users. Even worse, the cover can be over-rotated by an excessive force, resulting in damaging the hinge.

### BRIEF DESCRIPTION OF THE DRAWINGS

FIG. 1 is an exploded, isometric view of an exemplary embodiment of a hinge, the hinge including a first connecting member, a second connecting member, and a first interfering member.

FIG. 2 is an enlarged view of the first interfering member of FIG. 1, but viewed from another perspective.

FIG. 3 is similar to FIG. 1, but viewed from another perspective.

FIG. 4 is an assembled, isometric view of the hinge of FIG. 1.

FIG. 5 is an assembled, isometric view of the hinge of FIG. 3.

FIG. 6 is similar to FIG. 4, but showing the second connecting member being rotated an angle relative to the first connecting member.

### DETAILED DESCRIPTION

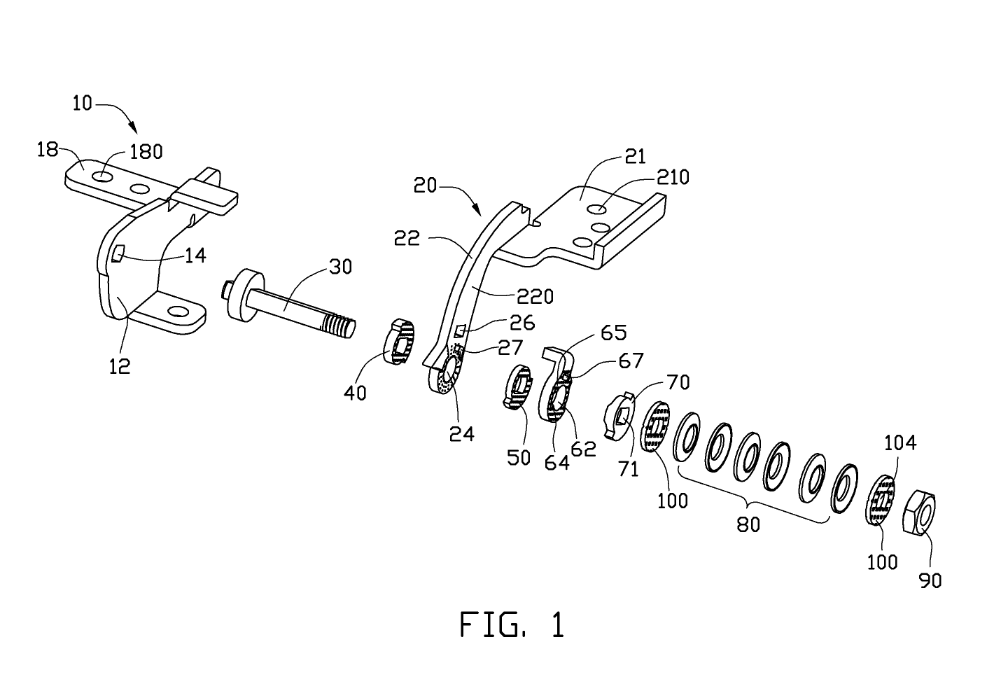

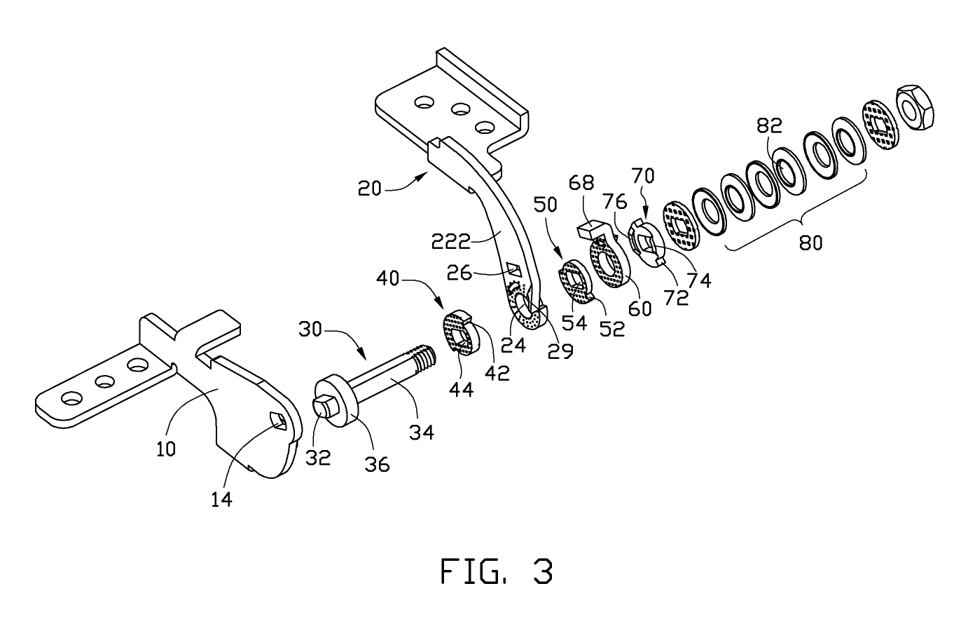

Referring to FIGS. 1 and 3, an exemplary embodiment of a hinge includes a first connecting member 10, a second connecting member 20, a shaft 30, a first stopping member 40, a second stopping member 50, a first interfering member 60, a second interfering member 70, a plurality of elastic rings 80, a fastener 90, and two friction members 100. In the embodiment, the fastener 90 is a nut.

The shaft 30 includes a fixing portion 32, a shaft body 34, and a resisting portion 36 between the fixing portion 32 and the shaft body 34. The fixing portion 32 has a double-D shaped cross-section for being fixed to the first connecting member 10. The shaft body 34 has a double-D shaped cross-section, and forms a threaded portion (not labeled) on a circumference of a distal end of the shaft body 34, for engaging with the fastener 90.

The first connecting member 10 includes a fixing board 12, and a connecting portion 18 perpendicularly extending from a side of the fixing board 12. The connecting portion 18 defines a plurality of fixing holes 180. The fixing board 12 defines a fixing hole 14 having a double-D shape, corresponding to the fixing portion 32 of the shaft 30, for fixing the shaft 30 to the first connecting member 10.

The second connecting member 20 includes a fixing body 21 defining a plurality of fixing holes 210, and a curved pivoting portion 22 extending from a side of the fixing body 21. The pivoting portion 22 includes a first side 220 and a second side 222 opposite to the first side 220. The pivoting portion 22 defines a through hole 24 and a fixing hole 26. The through hole 24 extends through the first and second sides 220 and 222 for allowing the shaft body 34 to rotatably pass therethrough. A wedge-shaped raised portion 27 protrudes out from the first side 220, and one end of the raised portion 27 is smoothly and slantingly connected to the first side 220. A wedge-shaped resisting block 29 protrudes out from the second side 222, along an edge of the pivoting portion 22 and neighboring to the through hole 24. One end of the second resisting block 29 is smoothly and slantingly connected to the second side 222.

The first and second stopping members 40 and 50 are similar to each other, and both of them are generally washer-shaped. Each of the first and second stopping members 40 and 50 defines an arc-shaped cutout (not labeled) along a circumference thereof, and each of opposite ends of each cutout forms a resisting surface 42, 52. Each of the first and second stopping members 40 and 50 defines a shaft hole 44, 54 in a center thereof, the shaft hole 44, 54 having a double-D shape, corresponding to the shaft body 34 of the shaft 30, for unrotatably fitting about the shaft body 34 of the shaft 30.

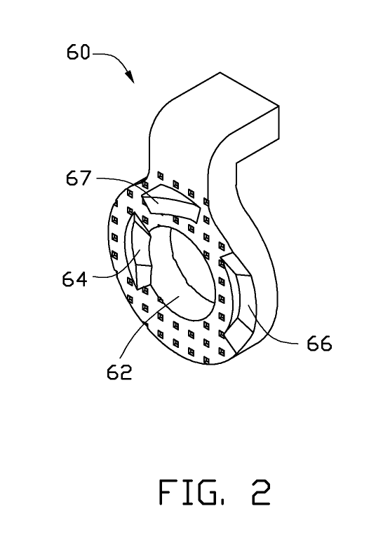

Referring to FIG. 2, the first interfering member 60 defines a round hole 62 therein, for allowing the shaft body 34 of the shaft 30 to rotatably pass therethrough. The first interfering member 60 includes a matching side 65 facing the second interfering member 70. A first depressed portion 64 and a second depressed portion 66 are defined in the matching side 65, opposite each other across the round hole 62. The first depressed portion 64 extends along a cambered edge of the round hole 62, and the second depressed portion 66 extends along an edge of the first interfering member 60. A wedge-shaped withstanding protrusion 67 protrudes from the matching side 65. A fixing post 68 axially extends inverse of the matching side 65 from the first interfering member 60.

The second interfering member 70 is generally washer-shaped. The second interfering member defines a cambered cutout (not labeled) along a circumference of the second interfering member 70, and opposite ends of the cutout forms a stopping surface 72. The second interfering member 70 defines a matching hole 71 having a double-D shape, corresponding to the shaft body 34 of the shaft 30, for unrotatably fitting about the shaft body 34 of the shaft 30. A first protrusion 74 and a second protrusion 76 extend from the second interfering member 70, opposite each other across the matching hole 71. The first protrusion 74 extends along an edge of the matching hole 71, and the second protrusion 76 extends adjacent to a circumference of the second interfering member 70.

Each elastic ring 80 provides elasticity along an axial direction of the shaft 30, to tighten the first connecting member 10, the second connecting member 20, both of the first and second stopping members 40 and 50, both of the first and second interfering members 60 and 70, and one of the friction members 100. Each elastic ring 80 defines a round through hole 82, allowing the shaft body 34 of the shaft 30 to rotatably pass therethrough.

Each friction member 100 defines a double-D shaped fixing hole 104, for unrotatably receiving the shaft body 34 of the shaft 30.

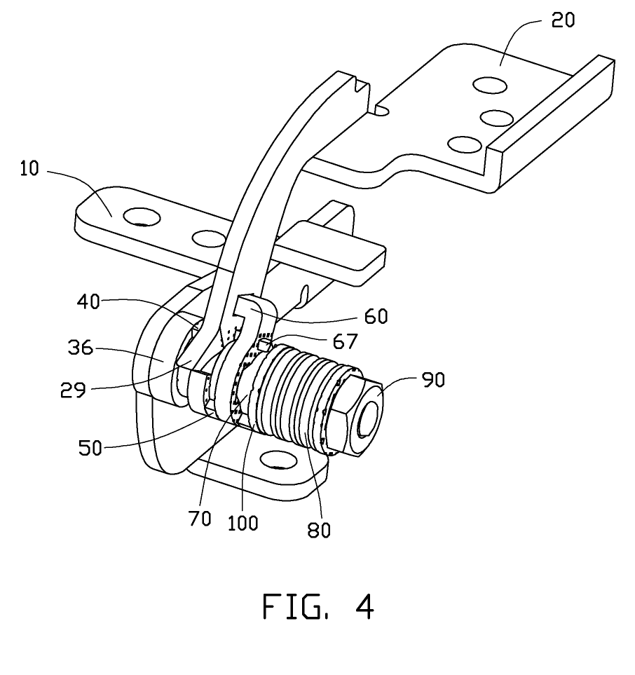

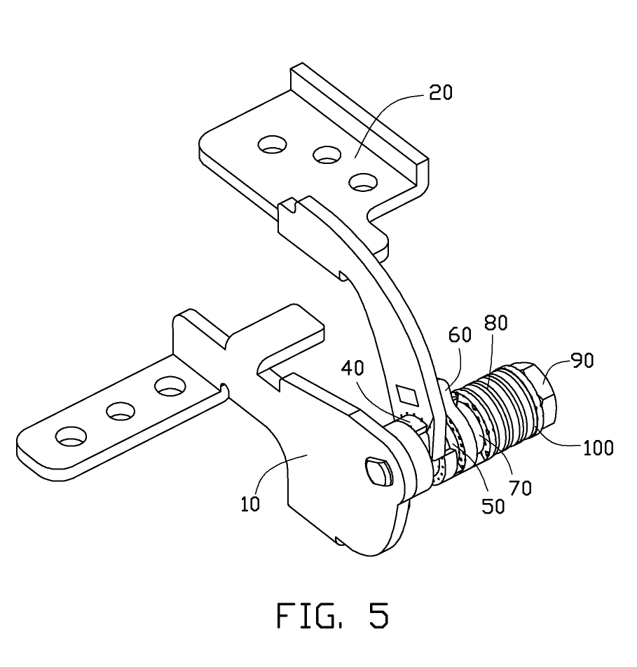

Referring to FIGS. 4 and 5, in assembly, the fixing portion 32 of the shaft 30 is fixedly received in the fixing hole 14 of the first connecting member 10, therefore, the shaft 30 is fixed to the first connecting member 10. The shaft body 34 of the shaft 30 is passed through the shaft hole 44 of the first stopping member 40, the through hole 24 of the second connecting member 20, the shaft hole 54 of the second stopping member 50, the round hole 62 of the first interfering member 60, the matching hole 71 of the second interfering member 70, the fixing hole 104 of one of the friction members 100, the through holes 82 of the plurality of elastic rings 80, and the fixing hole 104 of the other friction member 100 one by one in that order, with the distal end of the shaft body 34 engaging in the fastener 90 for preventing the second connecting member 20, the first and second stopping members 40 and 50, the first and second interfering members 60 and 70, the friction members 100, and the plurality of elastic rings 80 from disengaging from the shaft 30.

In the aforementioned assembly, the fixing post 68 of the first interfering member 60 is fixed in the fixing hole 26 of the second connecting member 20, therefore, the first interfering member 60 is rotated with the second connecting member 20. The raised portion 27 and the resisting block 29 of the second connecting member 20 are received in the cutouts of the first and second stopping members 40 and 50, respectively. The withstanding protrusion 67 is received in the cutout of the second interfering member 70. The first and second protrusions 74 and 76 of the second interfering member 70 are engaged in the first and second depressed portions 64 and 66, respectively.

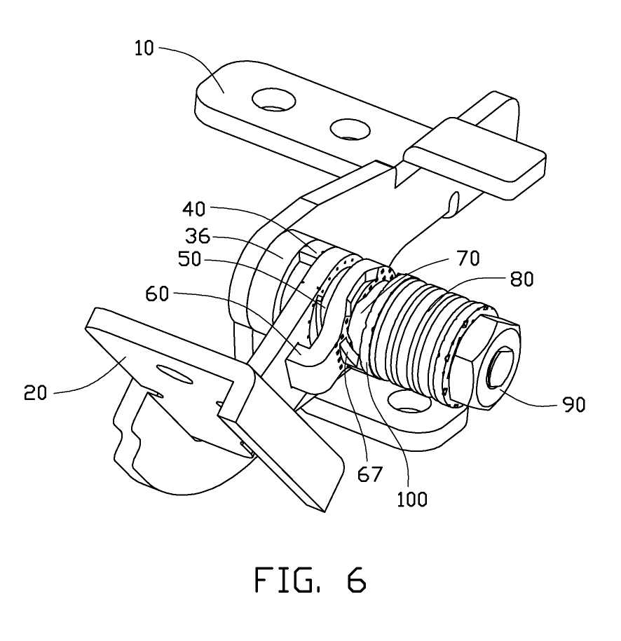

Referring to FIG. 6, in use, the first connecting member 10 is fixed to one of a cover and a base of a collapsible device (not shown), via the plurality of fixing holes 180, and the second connecting member 20 is fixed to the other one of the cover and the base of the collapsible device, via the plurality of fixing holes 210. Therefore, during rotation of the cover relative to the base, the second connecting member 20 rotates relative to the first connecting member 10, together with the first interfering member 60. As a result, the first and second protrusions 74 and 76 of the first interfering member 70 are moved onto the matching side 65 of the first interfering member 60, or into the first and second depressed portions 64 and 66 of the first interfering member 60, respectively, to deform or release the plurality of elastic rings 80. In the meanwhile, the raised portion 27 and the resisting block 29 of the second connecting member 20 correspondingly move towards one of the resisting surfaces 42 and one of the resisting surfaces 52 of the first and second stopping members 40 and 50. The withstanding protrusion 67 of the first interfering member 60 moves towards one of the stopping surfaces 72 of the second interfering member 70. When the second connecting member 20 is rotated to a predetermined degree relative to the first connecting member 10, the raised portion 27 and the resisting block 29 of the second connecting member 20 resist against the corresponding resisting surfaces 42 and 52 of the first and second stopping members 40 and 50, respectively, together with the withstanding protrusion 64 of the first interfering member 60 resisting against one of the stopping surfaces 72 of the second interfering member 70. Therefore, the second connecting member 20 cannot be rotated further relative to the first connecting member 10. As a result, the cover is stably maintained at the predetermined degree with respect to the base resulting preventing the cover from over-rotating.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a first connecting member;
a shaft fixed to the first connecting member, and comprising a shaft body;
a second connecting member rotatably mounted to the shaft body, a resisting block extending from the second connecting member;
a first interfering member fixed to the second connecting member and rotatably mounted on the shaft, a first depressed portion and a second depressed portion both defined in the first interfering member, a withstanding protrusion protruding from the first interfering member;
a first stopping member fixedly mounted to the shaft body, and comprising a resisting surface;
a second interfering member fixedly mounted to the shaft body, and comprising a stopping surface, a first protrusion and a second protrusion extending from the second interfering member, the first and second protrusions capable of engaging in or disengaging from the first and second depressed portions during rotation of the second connecting member relative to the first connecting member; and
a fastener fixed to a distal end of the shaft body, to prevent the second connecting member, the first and second interfering members, and the first stopping member from disengaging from the shaft body;
wherein when the second connecting member rotates to a predetermined degree relative to the first connecting member, the resisting block of the second connecting member resists against the resisting surface of the first stopping member, and simultaneously, the withstanding protrusion of the first interfering member resists against the stopping surface of the second interfering member.

2. The hinge of claim 1, wherein the second connecting member defines a fixing hole, a fixing post extends from the first interfering member, for being fixedly received in the fixing hole.

3. The hinge of claim 1, further comprising a second stopping member fixedly mounted to the shaft body, sandwiched between the second connecting member and the first interfering member, wherein the second stopping member comprises a resisting surface, a raised portion extends from the second connecting member, opposite to the resisting block, to resist against the resisting surface of the second stopping member.

4. The hinge of claim 1, wherein the shaft further comprises a resisting portion, and the shaft body extends from the resisting portion, opposite sides of the first stopping member resist against the resisting portion of the shaft and the second connecting member, respectively.

5. The hinge of claim 1, wherein the first interfering member defines a through hole for the shaft body being passed therethrough, the first and second depressed portions are opposite each other across the through hole.

6. The hinge of claim 1, wherein the first depressed portion extends along a cambered edge of the through hole, and the second depressed portion extends along a circumference of the first interfering member.

7. A hinge comprising:
a first connecting member;
a shaft fixed to the first connecting member, and comprising a shaft body;
a second connecting member rotatably mounted to the shaft body, a resisting block extending from the second connecting member;
a first interfering member fixed to the second connecting member and rotatably mounted on the shaft, a first depressed portion and a second depressed portion both defined in the first interfering member, a withstanding protrusion protruding from the first interfering member;
a first stopping member fixedly mounted to the shaft body, and comprising a resisting surface;
a second interfering member fixedly mounted to the shaft body, and comprising a stopping surface, a first protrusion and a second protrusion extending from the second interfering member; and
a plurality of elastic rings rotatably mounted to the shaft body; and
a fastener fixed to a distal end of the shaft body, to prevent the second connecting member, the first and second interfering members, the plurality of elastic rings, and the first stopping member from disengaging from the shaft body;
wherein during rotation of the second connecting member relative to the first connecting member, the first and second protrusions are correspondingly slid out or into the first and second depressed portions, to deform or release the plurality of elastic rings along an axial direction of the shaft; when the resisting block of the second connecting member resists against the resisting surface of the first stopping member, and simultaneously, the withstanding protrusion of the first interfering member resists against the stopping surface of the second interfering member, the second connecting member cannot be rotated further relative to the first connecting member.

8. The hinge of claim 7, wherein the second connecting member defines a fixing hole, a fixing post extends from the first interfering member, for being fixedly received in the fixing hole.

9. The hinge of claim 7, further comprising a second stopping member fixedly mounted to the shaft body, sandwiched between the second connecting member and the first interfering member, wherein the second stopping member comprises a resisting surface, a raised portion extends from the second connecting member, opposite to the resisting block, to resist against the resisting surface of the second stopping member.

10. The hinge of claim 7, wherein the shaft further comprises a resisting portion, and the shaft body extends from the resisting portion, opposite sides of the first stopping member resist against the resisting portion of the shaft and the second connecting member, respectively.

11. The hinge of claim 7, wherein the first interfering member defines a through hole for the shaft body being passed therethrough, the first and second depressed portions are opposite each other across the through hole.

12. The hinge of claim 11, wherein the first depressed portion extends along a cambered edge of the through hole, and the second depressed portion extends along a circumference of the first interfering member.

13. The hinge of claim 7, further comprising two friction members fixedly mounted to the shaft body, wherein the plurality of the elastic rings is sandwiched between the two friction members.
